(19) United States
(12) Patent Application Publication
(10) Pub. No.: US 2012/0068079 A1
(43) Pub. Date: Mar. 22, 2012

(54) RADIATION IMAGING APPARATUS AND STEREOSCOPIC IMAGE DISPLAY METHOD

(76) Inventors: Toshitaka AGANO, Kanagawa-ken (JP); Takao Kuwabara, Kanagawa-ken (JP); Yasuko Yahiro, Kanagawa-ken (JP); Yasunori Ohta, Kanagawa-ken (JP); Akira Hasegawa, San Jose, CA (US)

(21) Appl. No.: 13/239,009

(22) Filed: Sep. 21, 2011

Related U.S. Application Data
(60) Provisional application No. 61/385,413, filed on Sep. 22, 2010.

(51) Int. Cl. G01T 1/16

(52) U.S. Cl. 250/393; 250/395

(57) ABSTRACT

A high quality stereo image is displayed by a radiation imaging apparatus that obtains an image for two dimensional observation and two images for stereo display while using a grid. An input section 7 receives input of a user's dominant eye. Radiation image data obtained by imaging with an imaging angle of 0° is employed for an image for the dominant eye during stereo image display, and radiation image data corresponding to the eye opposite the user's dominant eye, from between radiation image data obtained by imaging with an imaging angle of +4° or +4°, are employed for an image for the other eye, to display a stereo image of a breast on a monitor 9.

### BACKGROUND OF THE INVENTION

1. Field of the Invention

The present invention is related to a radiation imaging apparatus for displaying image data for two images, a right eye image and a left eye image, employed to display a stereoscopic image. The present invention is also related to a stereoscopic image display method.

2. Description of the Related Art

Conventionally, it is known that stereoscopic viewing of images utilizing parallax is possible, by combining and displaying a plurality of images. An image that can be stereoscopically viewed (hereinafter, referred to as “stereoscopic image” or “stereo image”) is generated based on a plurality of images of a single subject obtained by imaging form different positions such that parallax exists therebetween.

Generation of such stereoscopic images is utilized not only in the fields of digital cameras and television, but also in the field of radiation imaging. That is, radiation is irradiated onto a patient from different directions, the radiation that passes through the patient is detected with a radiation image detector to obtain a plurality of radiation images having parallax therebetween, and a stereoscopic image is generated based on these radiation images. By generating the stereoscopic image in this manner, a radiation image having a sense of depth can be observed, which is more suited for diagnosis.

Generally, radiation imaging apparatuses for obtaining stereo images performs an imaging operation from the front of a radiation image detector (an angle formed by the imaging direction and a direction perpendicular to a detecting surface of the detector is) 0° in order to obtain an image for two dimensional observation, and also performs two imaging operations at converging angles (angles formed by the imaging directions and a direction perpendicular to a detecting surface of the detector are ±2°, for example) , to obtain a total of three images.

Providing a grid that absorbs scattered rays of radiation within a subject's body when performing radiation imaging is a known method by which high quality radiation images are generated. From among the three images obtained by the aforementioned imaging operations, it is desired for the image for two dimensional observation to be of the highest quality. Therefore, if a grid which is optimized for imaging from the front of the radiation image detector is employed, vignetting by the grid increases in cases that imaging is performed from imaging angles other than from the front of the radiation image detector, resulting in decreased dosage of radiation reaching the radiation detector.

Thereby, the S/N ratio of radiation images obtained by imaging from directions with large imaging angles is lower compared to the S/N ratio of images obtained by imaging from directions with small imaging angles. Therefore, when imaging is performed at imaging angles inclined to the left and right in order to obtain a stereo image as described above, a viewer will stereoscopically view a stereo image constituted by two radiation images having low S/N ratios, which may increase viewing fatigue.

### SUMMARY OF THE INVENTION

The present invention has been developed in view of the foregoing circumstances. It is an object of the present invention to provide a radiation imaging apparatus that displays a right eye image and a left eye image for displaying a stereoscopic image and a stereoscopic image display method that mitigate the above problem.

The present applicant discovered that stereoscopic display is possible even if the image quality of right and left images do not match. The present invention is based on this new knowledge. A radiation imaging apparatus of the present invention displays a stereoscopic image employing a right eye image and a left eye image, and is characterized by comprising:

a radiation detector that detects irradiated radiation and outputs the detected radiation as radiation image signals;

a radiation source that irradiates radiation toward a subject from three different imaging direction, including a first imaging direction that forms the smallest angle with respect to a direction perpendicular to a detecting surface of the radiation detector, a second imaging direction and a third imaging direction that form angles with respect to the direction perpendicular to the detecting surface of the radiation detector greater than that formed by the first imaging direction;

a grid provided between the subject and the radiation detector that absorbs scatters rays of the irradiated radiation, configured to be at the most appropriate placement for the first imaging direction from among the three imaging directions; and selecting means, for enabling selection of a combination of

a set of radiation image signals obtained by the first imaging direction and a set of radiation image signals obtained by the second imaging direction and a combination of the set of radiation image signals obtained by the first imaging direction and a set of radiation image signals obtained by the third imaging direction, when displaying the stereoscopic images.

It is preferable for the radiation imaging apparatus of the present invention to be of a configuration, wherein

the selecting means receives input of a user's dominant eye; and the radiation imaging apparatus further comprises display control means for displaying the set of radiation image signals obtained by the first imaging direction as the image for the dominant eye, and one of the set of radiation image signals obtained by the second imaging direction and the set of radiation image siynals obtained by the third imaging direction corresponding to the opposite side of the dominant eye as an image for the other eye. It is preferable for the angle formed by the first imaging direction and the direction perpendicular to the detecting surface of the radiation detector to be 0°. It is also preferable for the absolute value of the angle formed by the second imaging direction and the direction perpendicular to the detecting surface of the radiation detector and the absolute value of the angle formed by the third imaging direction and the direction perpendicular to the detecting surface of the radiation detector to be within a range from 4° to 15°, and more preferably, to be 4°.

A stereoscopic image display method of the present invention displays a stereoscopic image employing a right eye image and a left eye image by using a radiation imaging apparatus comprising: a radiation detector that detects irradiated radiation and outputs the detected radiation as radiation image signals; a radiation source that irradiates radiation toward a subject from three different imaging direction, including a first imaging direction that forms the smallest angle with respect to a direction perpendicular to a detecting surface of the radiation detector, a second imaging direction and a third imaging direction that form angles with respect to the direction perpendicular to the detecting surface of the radiation detector greater than that formed by the first imaging direction; and a grid provided between the subject and the radiation detector that absorbs scatters rays of the irradiated radiation, configured to be at the most appropriate placement for the first imaging direction from among the three imaging directions; and is characterized by comprising:

receiving input of a user's dominant eye; and displaying a set of radiation image signals obtained by the first imaging direction as the image for the dominant eye, and one of a set of radiation image signals obtained by the second imaging direction and a set of radiation image signals obtained by the third imaging direction corresponding to the opposite side of the dominant eye as an image for the other eye.

The radiation imaging apparatus of the present invention that displays a stereoscopic image employing a right eye image and a left eye image is equipped with the radiation detector that detects irradiated radiation and outputs the detected radiation as radiation image signals; the radiation source that irradiates radiation toward a subject from three different imaging direction, including a first imaging direction that forms the smallest angle with respect to a direction perpendicular to a detecting surface of the radiation detector, a second imaging direction and a third imaging direction that form angles with respect to the direction perpendicular to the detecting surface of the radiation detector greater than that formed by the first imaging direction; the grid provided between the subject and the radiation detector that absorbs scatters rays of the irradiated radiation, configured to be at the most appropriate placement for the first imaging direction from among the three imaging directions; and the selecting means, for enabling selection of a combination of radiation image signals obtained by the first imaging direction and radiation image signals obtained by the second imaging direction and a combination of radiation image signals obtained by the first imaging direction and radiation image signals obtained by the third imaging direction, when displaying the stereoscopic images. That is, at least one set of the set of radiation image signals to be employed for stereoscopic image display is that obtained by imaging from the first imaging direction having the high S/N ratio. Therefore, a higher quality stereoscopic image can be displayed compared to a case in which stereoscopic images are displayed employing two sets of radiation image signals both having low S/N ratios.

A configuration may be adopted, wherein: input of a user's dominant eye is received; and the set of radiation image signals obtained by the first imaging direction is displayed as the image for the dominant eye, and one of the set of radiation image signals obtained by the second imaging direction and the set of radiation image signals obtained by the third imaging direction corresponding to the opposite side of the dominant eye is displayed as an image for the other eye. In this case, an image which is capable of being viewed more easily by the user can be displayed.

### BRIEF DESCRIPTION OF THE DRAWINGS

FIG. 1 is a diagram that schematically illustrates a stereoscopic mammogram imaging system that employs a radiation imaging apparatus according to an embodiment of the present invention.

FIG. 2 is a view of an arm member of the stereoscopic mammogram imaging system of FIG. 1 from the rightward direction of FIG. 1.

FIG. 3 is a block diagram that schematically illustrates the interior of a computer of the stereoscopic mammogram imaging system of FIG. 1.

### DESCRIPTION OF THE PREFERRED EMBODIMENTS

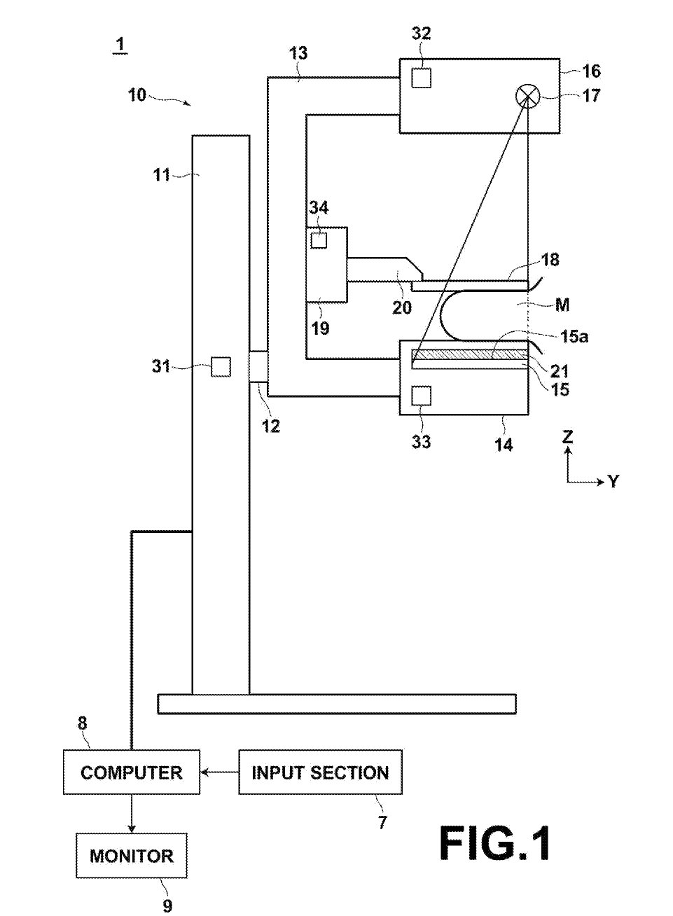

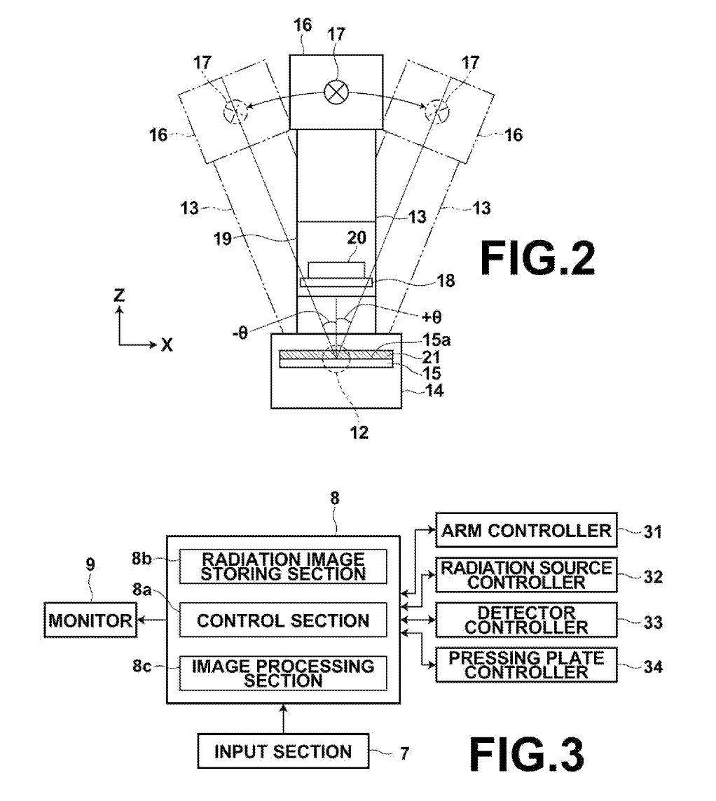

Hereinafter, a stereoscopic mammogram imaging system 1 that employs a radiation imaging apparatus according to an embodiment of the present invention will be described. First, the schematic structure of the stereoscopic mammogram imaging system 1 of the present embodiment will be described. FIG. 1 is a diagram that schematically illustrates the stereoscopic mammogram imaging system 1, FIG. 2 is a view of an arm member of the stereoscopic mammogram imaging system 1 of FIG. 1 from the rightward direction of FIG. 1, and FIG. 3 is a block diagram that schematically illustrates the interior of a computer of the stereoscopic mammogram imaging system 1 of FIG. 1.

As illustrated in FIG. 1, the stereoscopic mammogram imaging system 1 is equipped with: a mammography apparatus 10; a computer 8 connected to the mammography apparatus 10; and a monitor 9 and an input section 7 which are connected to the computer 8.

As illustrated in FIG. 1, the mammography apparatus 10 is equipped with: a base 11; a rotating shaft 12 which is rotatable and movable in the vertical direction (the Z direction) with respect to the base 11; and an arm member 13 which is linked to the base 11 via the rotating shaft 12. Note that FIG. 2 illustrates the arm member 13 as viewed from the right side of FIG. 1.

The arm member 13 is of a C shape. An imaging base 14 is mounted at one end of the arm member 13, and a radiation irradiating section 16 is mounted at the other end of the arm member 13 so as to face the imaging base 14 . Rotation and vertical movement of the arm member 13 are controlled by an arm controller 31 built in to the base 11.

A radiation detector 15, such as a flat panel detector, a grid 21 provided on a detecting surface 15a of the radiation detector 15, and a detector controller 33 for controlling readout of electric charge signals from the radiation detector 15, are provided in the interior of the imaging base 14.

The grid 21 is provided to absorb scattered rays of radiation. The grid 21 is constituted by radiation transmissive members and non radiation transmissive members, which are alternately arranged.

The grid is placed such that the non radiation transmissive members are inclined so as to optimize imaging when radiation is irradiated from a direction perpendicular to the detecting surface 15a. Thereby, the dosage of radiation that reaches the radiation detector 15 decreases as the angle formed between an imaging direction and the direction perpendicular to the detecting surface 15a (hereinafter, referred to as “imaging angle θ′”) increases, due to increased amounts of vignetting by the grid 21.

In addition, a circuit board with charge amplifiers for converting electric charges read out from the radiation detector 15 into voltage signals, a correlated double sampling circuit for sampling the voltage signals output from the charge amplifiers, and an A/D converting section for converting the voltage signals into digital signals, etc., is provided in the interior of the imaging base 14.

The imaging base 14 is configured to be rotatable with respect to the arm member 13, such that the orientation of the imaging base 14 can be fixed with respect to the base 11 even when the arm member 13 is rotated with respect to the base 11. The radiation image detector 15 is capable of repeatedly recording and reading out radiation images. The radiation image detector 15 may be a so called direct type radiation image detector that directly receives radiation and generates electric charges. Alternatively, the radiation image detector 15 may be a so called indirect type radiation image detector that converts radiation to visible light, then converts the visible light to electric charges. In addition, it is desirable for the readout method employed by the radiation image detector 15 to be the so called TFT readout method that reads out radiation image signals by turning TFT's (Thin Film Transistors) ON and OFF, or the so called optical readout method that irradiates readout light to read out radiation image signals. However, the present invention is not limited to these readout methods, and other methods may be employed. The radiation image signals output from the radiation image detector 15 are A/D converted to become radiation image data.

A radiation source 17 and a radiation source controller 32 are provided in the radiation irradiating section 16. The radiation source controller 32 controls the timing at which radiation is irradiated by the radiation source 17, and radiation generating conditions (bulb current, time, bulb current time product, etc.) of the radiation source 17.

A pressing plate 8 for compressing a breast M, a support member 20 that supports the pressing plate 18, and a moving mechanism for moving the support member 20 in the vertical direction (the Z direction) are provided at the central portion of the arm member 13 above the imaging base 14. The position of the pressing plate 18 and a compression pressure are controlled by a pressing plate controller 34.

The computer 8 is equipped with a CPU (Central Processing Unit) and a storage device such as a semiconductor memory, a hard disk, or an SSD. These hardware components constitute a control section 8a, a radiation image storing section 8b, and an image processing section 8c illustrated in FIG. 3.

The control section 8a outputs predetermined control signals to each of the controllers 31 through 34, to control the entirety of the system. The specific methods of control will be described later. The radiation image storing section 8b stores radiation image data obtained by the radiation image detector by imaging with each imaging angle. The image processing section 8c administers various image processes onto the radiation image data.

The input section 7 is constituted by a keyboard and a pointing device, such as a mouse, for example. The input section 7 is configured to receive input of a user's dominant eye. In addition, the input section 7 also receives input of imaging conditions and operating commands from an operator.

The monitor 9 is configured to display radiation images for obtained by different imaging directions output by the computer 8 as two dimensional images, to display a stereoscopic image.

Two radiation images based on two sets of radiation image data may be displayed on two screens, a half mirror or a polarizing plate may be employed to cause one of the radiation images to enter the right eye of an observer, and the other of the radiation images to enter the left eye of the observer, as a configuration for displaying the stereo image.

Alternatively, two radiation images may be displayed in an overlapping manner, shifted for a predetermined amount of parallax, and viewed through polarizing glass in order to generate a stereo image. As a further alternative, two radiation images may be displayed on a 3D liquid crystal display capable of being stereoscopically viewed as in the parallax barrier method and the lenticular method, to generate a stereo image.

In addition, the apparatus for displaying stereo images and the apparatus for displaying two dimensional images may be configured as separate apparatuses, or may be configured as a single apparatus in the case that the stereo images and two dimensional images can be displayed on the same screen.

Next, the operation of the mammogram imaging system of the present embodiment will be described.

First, an imaging operation will be described.

First, a breast M is placed on the imaging base 14, and is compressed by the pressing plate 18 at a predetermined pressure.

Next, various imaging conditions including a convergence angle θ of a stereo image and an imaging initiation command are input via the input section 7. After the imaging initiation command is input via the input section 7, imaging of a stereo image of the breast M is performed. Specifically, first, the control section 8a outputs data regarding an actual imaging angle θ′=+θ and an actual imaging angle θ′=−θ to the arm controller 31, based on the input convergence angle θ. Note that in the present embodiment, data regarding the convergence angle θ is set as θ=4°, and the combination of actual imaging angles θ′ is set as θ′=±4°. However, the present invention is not limited to employing these settings, and an operator is capable of setting desired a convergence angle θ via the input section 7. Note that it is desirable for the convergence angle θ to be within a range from 4° to 15°, because appropriate stereoscopic viewing becomes difficult if the convergence angle θ is excessively large or excessively small.

As illustrated in FIG. 2, the arm controller 31 receives data regarding a first imaging angle θ′ output by the control section 8a. The arm controller 31 outputs a control signal to incline the arm member 13 with respect to a direction perpendicular to the detecting surface 15a to realize an imaging angle θ′ of +4° based on the data regarding the imaging angle θ′. The arm member 13 rotates +4° in response to the control signal output from the arm controller 31. Next, the control section 8a outputs control signals to the radiation source controller 32 and the detector controller 33 to perform irradiation of radiation and readout of a radiation image. In response to these control signals, the radiation source 17 emits radiation and a radiation image of the breast M obtained by imaging with an imaging angle θ′ of +4° is detected by the radiation detector 15, radiation image data are read out by the detector controller 33, and the read out radiation image data are stored in the radiation image storing section 8b. Note that the radiation image data of which the imaging angle θ′ is +4° are employed only for a right eye image for stereoscopic display.

Similarly, as illustrated in FIG. 2, the arm controller 31 receives data regarding a second imaging angle θ′ output by the control section 8a. The arm controller 31 outputs a control signal to incline the arm member 13 with respect to a direction perpendicular to the detecting surface 15a to realize an imaging angle θ′ of −4° based on the data regarding the imaging angle θ′.

The arm member 13 rotates −4° in response to the control signal output from the arm controller 31. Next, the control section 8a outputs control signals to the radiation source controller 32 and the detector controller 33 to perform irradiation of radiation and readout of a radiation image. In response to these control signals, the radiation source 17 emits radiation and a radiation image of the breast M obtained by imaging with an imaging angle θ′ of −4° is detected by the radiation detector 15, radiation image data are read out by the detector controller 33, and the read out radiation image data are stored in the radiation image storing section 8b. Note that the radiation image data of which the imaging angle θ′ is −4° are employed only for a left eye image for stereoscopic display.

Next, as illustrated in FIG. 2, the arm controller 31 outputs a control signal to move the arm member 13 such that it is oriented in a direction perpendicular to the detecting surface 15a, in order to obtain an image for two dimensional observation. That is, in the present embodiment, the arm controller 32 outputs a control signal to realize an imaging angle θ′ of 0° with respect to the direction perpendicular to the detecting surface 15a.

Note that it is desirable for the imaging angle when obtaining the image for two dimensional observation to be 0° because images obtained by imaging from the front surface of the radiation image detector 15 are most suited for two dimensional observation. However, it is not necessary for the imaging angle to be 0°, and other angles may be adopted.

The arm member 13 is oriented in a direction perpendicular to the detecting surface 5a in response to the control signal output from the arm controller. Next, the control section 8a outputs control signals to the radiation source controller 32 and the detector controller 33 to perform irradiation of radiation and readout of a radiation image. In response to these control signals, the radiation source 17 emits radiation and a radiation image of the breast M obtained by imaging with an imaging angle θ′ of 0° is detected by the radiation detector 15, radiation image data are read out by the detector controller 33, and the read out radiation image data are stored in the radiation image storing section 8b. Note that the radiation image data of which the imaging angle θ′ is 0° are employed both for an image for two dimensional observation and also for an image for a dominant eye during stereoscopic display.

Next, the stereoscopic image display operation will be described.

First, input of a user's dominant eye is received via the input section 7. Note that the timing at which the input of a user's dominant eye is received may be any timing, such as immediately prior to display of the stereo image, and immediately prior to imaging operations. In addition, input of the user's dominant eye may be received in advance, the contents of the input may be stored, and the data regarding the user's dominant may be reflected during image display.

The radiation image data obtained by imaging with an imaging angle of 0° are employed for an image for the dominant eye during stereoscopic display, and radiation image data corresponding to the eye opposite the dominant eye from between the radiation data obtained by imaging with the imaging angle of +4° and the radiation data obtained by imaging with the imaging angle of −4° are employed for an image for the eye opposite the dominant eye. The two sets of radiation image data are read out from the radiation image storing section 8b of the computer 8, predetermined signal processes are administered thereon, radiation images are output to the monitor 9, then a stereo image of the breast M is displayed on the monitor 9.

In the case that the user requests two dimensional image display, the radiation image data obtained by imaging with the imaging angle of 0° are read out from the radiation image storing section 8b of the computer 8, output to the monitor 9 after predetermined signal processes are administered thereon, and a two dimensional image of the breast M is displayed on the monitor 9.

In this manner, the set of radiation image data obtained by imaging with the imaging angle of 0°, which has a high S/N ratio, is employed as one of the sets of radiation image data for stereoscopic image display. Therefore, a stereoscopic image having higher image quality compared to a case in which stereoscopic images are displayed employing the two sets of radiation image signals obtained by imaging with imaging angles of ±4°, which both have low S/N ratios. In addition, the set of radiation image data obtained by imaging with the imaging angle of 0°, which has a high S/N ratio, is employed for the image for the dominant eye. Therefore, an image which is capable of being viewed more easily by the user can be displayed.

In the description of the above embodiment, input of the user's dominant eye is received, and a combination of the set of radiation image data obtained by imaging with the imaging angle of 0° and the set of radiation image data obtained by imaging with the imaging angle of +4° or a combination of the set of radiation image data obtained by imaging with the imaging angle of 0° and the set of radiation image data obtained by imaging with the imaging angle of −4° is selected. However, the present invention is not limited to such a configuration. A configuration may be adopted, in which an input means such as a switch that enables selection of either of the two combinations may be provided, and users may select a preferred combination regardless of their dominant eyes.

In addition, the radiation imaging apparatus of the present invention is described as a mammogram imaging system in the above embodiment. However, the subject of imaging is not limited to breasts, and the radiation imaging apparatus of the present invention may be those that obtain and display radiation images of the thorax, the head, or the like.

What is claimed is:

1. A radiation imaging apparatus that displays a stereoscopic image employing a right eye image and a left eye image, comprising:
a radiation detector that detects irradiated radiation and outputs the detected radiation as radiation image signals;
a radiation source that irradiates radiation toward a subject from three different imaging direction, including a first imaging direction that forms the smallest angle with respect to a direction perpendicular to a detecting surface of the radiation detector, a second imaging direction and a third imaging direction that form angles with respect to the direction perpendicular to the detecting surface of the radiation detector greater than that formed by the first imaging direction;
a grid provided between the subject and the radiation detector that absorbs scatters rays of the irradiated radiation, configured to be at the most appropriate placement for the first imaging direction from among the three imaging directions; and
selecting means, for enabling selection of a combination of a set of radiation image signals obtained by the first imaging direction and a set of radiation image signals obtained by the second imaging direction and a combination of the set of radiation image signals obtained by the first imaging direction and a set of radiation image signals obtained by the third imaging direction, when displaying the stereoscopic images.

2. A radiation imaging apparatus as defined in claim 1, wherein:
the selecting means receives input of a user's dominant eye; and
the radiation imaging apparatus further comprises display control means for displaying the radiation image signals obtained by the first imaging direction as the image for the dominant eye, and one of the set of radiation image signals obtained by the second imaging direction and the set of radiation image signals obtained by the third imaging direction corresponding to the opposite side of the dominant eye as an image for the other eye.

3. A radiation imaging apparatus as defined in claim 1, wherein:
the angle formed by the first imaging direction and the direction perpendicular to the detecting surface of the radiation detector is 0°.

4. A radiation imaging apparatus as defined in claim 2, wherein:
the angle formed by the first imaging direction and the direction perpendicular to the detecting surface of the radiation detector is 0°.

5. A radiation imaging apparatus as defined in claim 1, wherein:
the absolute value of the angle formed by the second imaging direction and the direction perpendicular to the detecting surface of the radiation detector and the absolute value of the angle formed by the third imaging direction and the direction perpendicular to the detecting surface of the radiation detector are within a range from 4° to 15°.

6. A radiation imaging apparatus as defined in claim 2, wherein:
the absolute value of the angle formed by the second imaging direction and the direction perpendicular to the detecting surface of the radiation detector and the absolute value of the angle formed by the third imaging direction and the direction perpendicular to the detecting surface of the radiation detector are within a range from 4° to 15°.

7. A radiation imaging apparatus as defined in claim 3, wherein:
the absolute value of the angle formed by the second imaging direction and the direction perpendicular to the detecting surface of the radiation detector and the absolute value of the angle formed by the third imaging direction and the direction perpendicular to the detecting surface of the radiation detector are within a range from 4° to 15°.

8. A radiation imaging apparatus as defined in claim 4, wherein:
the absolute value of the angle formed by the second imaging direction and the direction perpendicular to the detecting surface of the radiation detector and the absolute value of the angle formed by the third imaging direction and the direction perpendicular to the detecting surface of the radiation detector are within a range from 4° to 15°.

9. A radiation imaging apparatus as defined in claim 1, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

10. A radiation imaging apparatus as defined in claim 2, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

11. A radiation imaging apparatus as defined in claim 3, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

12. A radiation imaging apparatus as defined in claim 4, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

13. A radiation imaging apparatus as defined in claim 5, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

14. A radiation imaging apparatus as defined in claim 6, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

15. A radiation imaging apparatus as defined in claim 7, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

16. A radiation imaging apparatus as defined in claim 8, wherein:
the absolute value of the absolute value of the angle formed by the second imaging direction and the direction perpendicular to the detecting surface of the radiation detector and the absolute value of the angle formed by the third imaging direction and the direction perpendicular to the detecting surface of the radiation detector is 4°.

17. A stereoscopic image display method, for displaying a stereoscopic image employing a right eye image and a left eye image by using a radiation imaging apparatus comprising: a radiation detector that detects irradiated radiation and outputs the detected radiation as radiation image signals; a radiation source that irradiates radiation toward a subject from three different imaging direction, including a first imaging direction that forms the smallest angle with respect to a direction perpendicular to a detecting surface of the radiation detector, a second imaging direction and a third imaging direction that form angles with respect to the direction perpendicular to the detecting surface of the radiation detector greater than that formed by the first imaging direction; and a grid provided between the subject and the radiation detector that absorbs scatters rays of the irradiated radiation, configured to be at the most appropriate placement for the first imaging direction from among the three imaging directions; comprising:
receiving input of a user's dominant eye; and
displaying a set of radiation image signals obtained by the first imaging direction as the image for the dominant eye, and one of a set of radiation image signals obtained by the second imaging direction and a set of radiation image signals obtained by the third imaging direction corresponding to the opposite side of the dominant eye as an image for the other eye.
